(19) United States
(12) Patent Application Publication
(10) Pub. No.: US 2002/0193220 A1
(43) Pub. Date: Dec. 19, 2002

(54) Paper-web guide apparatus

(75) Inventors: Akira Motegi, Yokosuka-shi (JP); Kinichiroh Ohno, Tokyo (JP); Noboru Fujio, Hamura-shi (JP)

Correspondence Address: ARMSTRONG,WESTERMAN & HATTORI, LLP, 1725 K STREET, NW., SUITE 1000, WASHINGTON, DC, 20006, US

(73) Assignee: Tokyo Kikai Seisakusho, Ltd., Tokyo (JP)

(21) Appl. No.: 10/119,140

(22) Filed: Apr. 10, 2002

(30) Foreign Application Priority Data
Jun. 4, 2001 (JP) 2001-168489

(51) Int. Cl. B31B 1/14

(52) U.S. Cl. 493/81

(57) ABSTRACT

A paper-web guide apparatus includes a guide member having a vibration guide surface which is curved about an axis and is adapted to guide the paper web toward a desired direction, and a vibration excitation unit for vibrating the guide member about the axis to thereby generate ultrasonic torsion vibration on the vibration guide surface. The vibration guide surface may be further displacable about the axis, and a displacement drive unit for displacing the curved vibration guide surface about the axis may be provided. When the vibration excitation unit is operated, the guide member is twisted about the axis and thus ultrasonic torsion vibration is generated on the curved vibration guide surface. As a result, antinodes and nodes of vibration appear on the curved vibration guide surface, whereby frictional resistance between the paper web and the curved guide surface decreases. Further, since the curved vibration guide surface comes into sliding contact with the paper web while displacing about the axis, the guide surface is hardly dirtied by ink transfer.

### BACKGROUND OF THE INVENTION

1. Field of the Invention

The present invention relates to a paper-web guide apparatus for a processing machine, such as a rotary press, which processes a paper web while causing the paper web to travel. More particularly, the invention relates to a paper-web guide apparatus which reduces frictional resistance acting against a traveling paper web to thereby prevent large tension from being exerted against the paper web.

2. Description of the Related Art

For example, Japanese Utility-Model Application Laid-Open (kokai) No. 4-45732, Japanese Patent Publication (kokoku) No. 7-119105, and Japanese Patent No. 2858653 disclose conventional paper-web guide apparatuses for rotary presses, each designed so as to reduce frictional resistance acting against a traveling paper web to thereby prevent large tension from being exerted against the paper web.

Specifically, Japanese Utility-Model Application Laid-Open No. 4-45732 discloses a turn-bar apparatus configured so as to jet air from a turn bar, which guides a paper web traveling through a rotary press, to thereby lift the paper web from the turn bar by the action of the jetted air and thus decrease frictional resistance; a turn-bar apparatus configured so as to impart to the turn bar vibration having a very small amplitude and a frequency higher than the natural frequency of the turn bar, to thereby lift the paper web from the turn bar by the action of the vibration and thus decrease frictional resistance; and a turn-bar apparatus configured so as to jet air from the turn bar and impart to the turn bar vibration having a very small amplitude and a frequency higher than the natural frequency of the turn bar, to thereby lift the paper web from the turn bar by the action of the jetted air and the vibration and thus decrease frictional resistance.

Japanese Patent Publication No. 7-119105 discloses a guide apparatus configured so as to generate traveling waves on a guide surface, which guides a paper web traveling through a rotary press, in such a manner that the traveling waves travel in the direction opposite the travel direction of the paper web and that the guide surface comes into contact with the paper web at peaks of the wave motion of the traveling waves, to thereby decrease frictional resistance. In addition, the guide apparatus positively guides the paper web toward the travel direction through utilization of the phenomenon such that any point on the guide surface displaces in the direction opposite the travel direction of the traveling waves due to the wave motion of the traveling waves.

Japanese Patent No. 2858653 discloses a web guide apparatus configured in such a manner that a guide surface, which guides a paper web traveling through a rotary press, is provided with protrusions having an aspect ratio (ratio of width to height) of 0.8 to 2 and is caused to vibrate at high frequency; or in such a manner that the guide surface is provided with protrusions having an aspect ratio of 0.8 to 2 and covered with a thin shell or film, and is caused to vibrate at high frequency. In the web guide apparatus, energy concentrates at the protrusions present between grooves, resulting in increased vibration amplitude without any increase in energy consumption. As a result, the paper web is not able to follow the vibration of the guide surface and contact time decreases. Through utilization of this phenomenon, frictional resistance is reduced.

Of the turn-bar apparatuses disclosed in Japanese Utility-Model Application Laid-Open No. 4-45732, the turn-bar apparatus configured so as to jet air from the turn bar toward a traveling paper web along the entire width of the paper web requires precise control of the supply pressure of air to be jetted and involves a problem in that ink is transferred to the turn bar and dirties the paper web slightly, because the paper web comes into contact with the turn bar surface at irregular intervals due to variations in travel tension acting on the paper web.

Moreover, there frequently arises a problem such that a lateral edge of the paper web is lifted by air jetted from an air jetting opening provided at a portion corresponding to the lateral edge of the paper web, and the jetted air hits the surface of the lifted portion of the paper web and generates force in the direction perpendicular to the jetting direction of air and perpendicular to the guided direction of the paper web, with the result that the paper web moves in the direction perpendicular to the jetting direction of air and perpendicular to the guided direction of the paper web and deviates from the normal travel position.

Of the turn-bar apparatuses disclosed in Japanese Utility-Model Application Laid-Open No. 4-45732, the turn-bar apparatus configured so as to impart to the turn bar vibration having a very small amplitude and a frequency higher than the natural frequency of the turn bar requires a large amount of energy such as electric power and increases manufacturing cost due to its complicated structure, as described in the Prior Art section of the Patent No. 2858653, the applicant of which is the same as that of the Japanese Utility-Model Application Laid-Open No. 4-45732. In addition, when vibrations are standing waves, the same portion of the turn bar vibrates and comes into contact with the paper web, so that ink is transferred to the contact portion and dirties the paper web slightly.

Of the turn-bar apparatuses disclosed in Japanese Utility-Model Application Laid-Open No. 4-45732, the turn-bar apparatus configured so as to jet air from the turn bar and impart to the turn bar vibration having a very small amplitude and a frequency higher than the natural frequency of the turn bar has all the problems described above in connection with the other two turn-bar apparatuses.

The guide apparatus disclosed in Japanese Patent Publication No. 7-119105 has a complicated structure. Therefore, manufacturing of such a guide apparatus is cumbersome and requires skill, and manufacturing cost is high.

Of the web guide apparatuses disclosed in Japanese Patent No. 2858653, the web guide apparatus configured to provide protrusions having an aspect ratio (ratio of width to height) of 0.8 to 2 involves the following drawback, since constant portions of the protrusions cause standing wave vibrations and come into contact with a paper web. That is, the portions of the guide surface which come into contact with the paper web and receive tension are limited as compared with the turn bar apparatus disclosed in the Japanese Utility-Model Application Laid-Open No. 4-45732, which is configured so as to impart to the turn bar vibration having a very small amplitude and a frequency higher than the natural frequency of the turn bar. Therefore, the protrusions come into contact with the paper web with stronger force, and a larger amount of ink is transferred to the contact portions and dirties the paper web to a greater degree.

Moreover, since the protrusions form a large number of relatively large steps, wrinkles may be formed in the paper web due to the steps.

Of the web guide apparatuses disclosed in Japanese Patent No. 2858653, the web guide apparatus configured to provide protrusions having an aspect ratio of 0.8 to 2 and cover the protrusions with a thin shell or film has a drawback in that, since the main body having protrusions and the thin shell or film are completely separated members, vibrations having a high frequency (10 to 40 kHz) and a small amplitude (several micrometers) fail to be transmitted to the thin shell or film sufficiently, resulting in failure to obtain a desired effect.

### SUMMARY OF THE INVENTION

An object of the present invention is to provide a paper-web guide apparatus for guiding toward a desired direction a paper web travelling through a processing apparatus, which can reduce frictional resistance acting on the paper web to thereby avoid application of large tension onto the paper web, which prevents the paper web from deviating from a proper travel position, which hardly dirties the paper web even when the guide surface comes into contact with the paper web, and which has a simplified structure.

The present invention provides a paper-web guide apparatus for a processing apparatus which processes a paper web while causing the paper web to travel, the paper-web guide apparatus comprising: a guide member having a vibration guide surface which is curved about an axis and is adapted to guide the paper web toward a desired direction; and a vibration excitation unit for vibrating the guide member about the axis to thereby generate ultrasonic torsion vibration on the vibration guide surface.

The present invention further provides a paper-web guide apparatus for a processing apparatus which processes a paper web while causing the paper web to travel, the paper-web guide apparatus comprising: a guide member having a guide surface which is curved about an axis and adapted to guide the paper web toward a desired direction, the guide surface including curved vibration guide surfaces for guiding at least lateral edges of the paper web and portions in the vicinity thereof, and a curved gas-jetting guide surface; a vibration excitation unit for vibrating the guide member about the axis to thereby generate ultrasonic torsion vibration on the vibration guide surfaces; and a gas supply section which is connected to gas-jetting openings formed in the gas-jetting guide surface.

Preferably, the curved guide surface is axially divided into three surfaces, and the center surface serves as the curved gas-jetting guide surface.

Preferably, the curved vibration guide surface of the guide member which is caused to produce ultrasonic torsion vibration can be displaced about the axis, and a displacement drive unit for displacing the curved vibration guide surface about the axis is provided.

Preferably, the guide member has a circular cross section as viewed perpendicular to the axis of the guide member.

The paper-web guide apparatus having the above-described configuration operates as follows. When the vibration excitation unit is operated, the guide member is twisted about the axis and thus ultrasonic torsion vibration is generated on the curved vibration guide surface.

As a result, at equally spaced axial positions, the spacing interval varying with the frequency of vibration, the guide member has at least two portions (hereinafter referred to as “antinodes”) which displace in directions opposite each other, as in the case in which a wet cloth is wrung out, and the directions of displacement are reversed at short time intervals that vary with the frequency. In addition, between adjacent antinodes, a portion (hereinafter referred to as a “node”) appears which does not displace about the axis. In each of the regions between the antinodes and the node, displacement about the axis occurs in the same direction as in the nearest antinode, and the amount of displacement decreases gradually toward the node.

Due to this displacement, as in the case in which a wet cloth is wrung out, the outer diameter of the nodes decreases, and the outer diameter of the antinodes increases. When the displacement of the antinodes reaches a maximum, the outer diameter of the nodes becomes smallest, and the outer diameter of the antinodes becomes largest.

When antinodes and nodes appear on the curved vibration guide surface, the antinodes, having larger diameters, lift the paper web and the nodes, having smaller diameters, separate from the paper web, so that the contact area between the travelling paper web and the curved vibration guide surface for guiding the paper web becomes very small, thus reducing frictional resistance. Further, since the curved vibration guide surface comes into sliding contact with the paper web while displacing about the axis, the guide surface is hardly dirtied by ink transfer.

In the structure wherein the curved guide surface includes a curved gas-jetting guide surface, the gas supply mechanism is operated simultaneously with activation of the vibration excitation unit to thereby jet gas from the jetting openings formed in the gas-jetting guide surface. As a result, the paper web lifts from the curved gas-jetting guide surface, and thus the frictional resistance is reduced further. Moreover, the guide surfaces for guiding at least lateral edges of the paper web and portions in the vicinity thereof serve as curved vibration guide surfaces, whereby the contact area is reduced by the action of ultrasonic torsion vibration, with a resultant decrease in frictional resistance, and deviation of the travel position of the paper web is prevented.

In the structure wherein the curved vibration guide surface is displacable about the axis, the displacement drive means is operated so as to displace the curved vibration guide surface at a speed differing from the travel speed of the paper web, so that the guide start position at which the travelling paper web starts to change its traveling direction along the curved vibration guide surface and the guide end position at which the travelling paper web ends the changing of its traveling direction along the curved vibration guide surface are changed at all times in order to prevent accumulation, at the guide start position and the guide end position, of paper powder or other matter which is transported by the traveling paper web. Thus, the conventional problem of accumulated debris breaking, falling, and dirtying the paper web can be solved completely.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a perspective view of a paper-web guide apparatus according to a first embodiment of the present invention;

FIG. 2 is a partially sectioned view as viewed in the direction of arrow II in FIG. 1;

FIG. 3 is a sectional view taken along the line III-III in FIG. 2;

FIG. 4 is a sectional view taken as viewed in the direction of arrow IV in FIG. 2;

FIG. 5 is a perspective view of a paper-web guide apparatus according to a second embodiment of the present invention;

FIG. 6 is a partially sectioned view as viewed in the direction of arrow VI in FIG. 5 (the portion 3R is a cross-sectional view taken along the line VI(R)-VI(R) in FIG. 7);

FIG. 7 is a sectional view taken along the line VII-VII in FIG. 6;

FIG. 8 is a perspective view of a paper-web guide apparatus according to a third embodiment of the present invention;

FIG. 9 is a partially sectioned view as viewed in the direction of arrow IX in FIG. 8 (the portion 5R is a cross-sectional view taken along the line IX(R)-IX(R) in FIG. 10);

FIG. 10 is a sectional view taken along the line X-X in FIG. 9;

FIG. 11 is a perspective view of the paper-web guide apparatus according to the third embodiment, which is implemented in the form of an angle bar; and

FIG. 12 is a schematic view showing a state in which debris are accumulated on the curved vibration guide surface of the guide member of the paper-web guide apparatus according to the embodiment of the present invention, in an area immediately before a position at which contact between the guide surface and the paper web starts and in area immediately after a position at which contact between the guide surface and the paper web ends.

### DESCRIPTION OF THE PREFERRED EMBODIMENTS

Embodiments of the present invention will next be describe in detail with reference to the drawings.

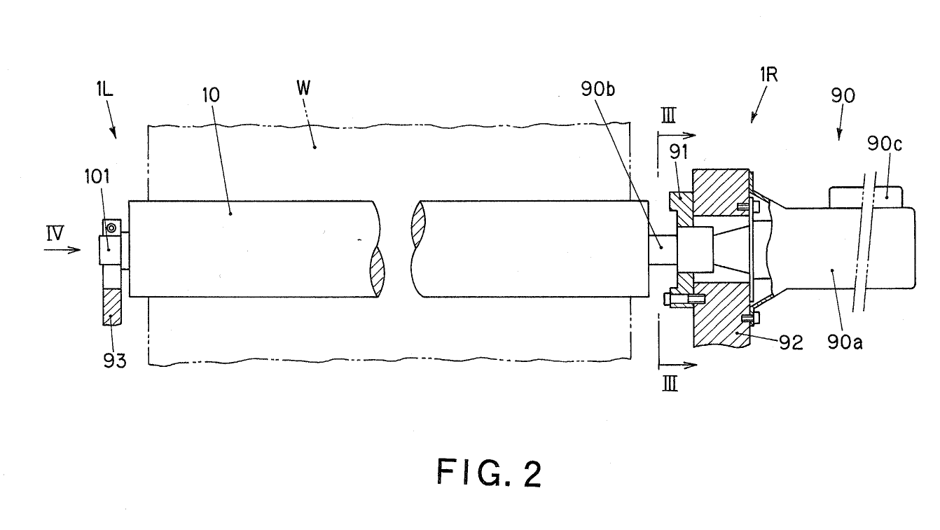

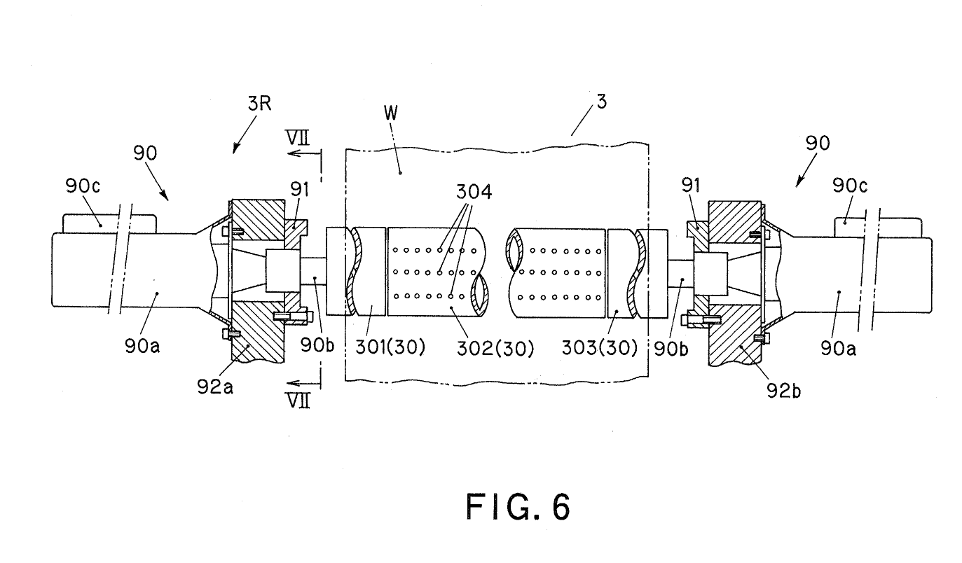

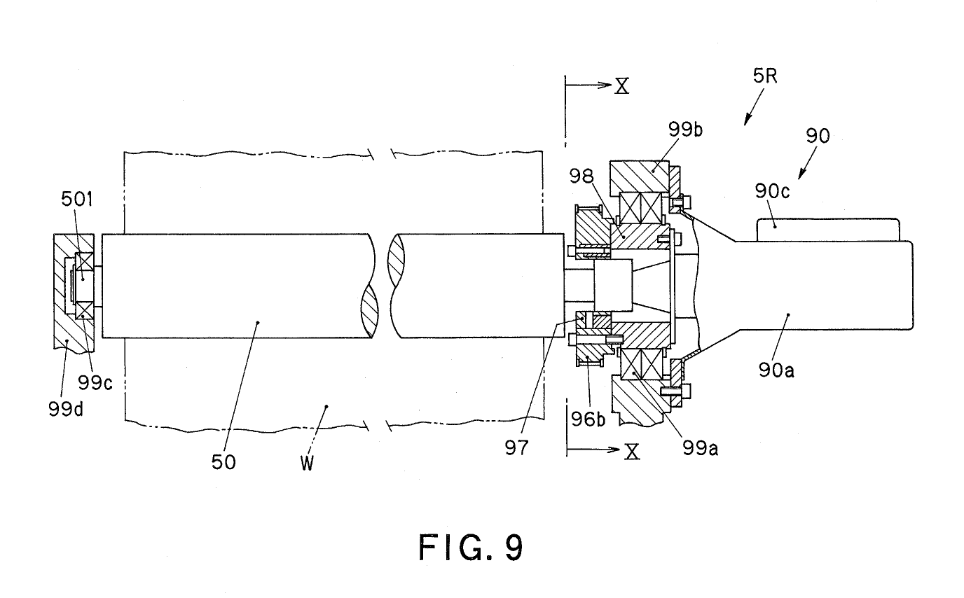

In the following description, the directions left and right are those as viewed in FIGS. 2, 6, and 9.

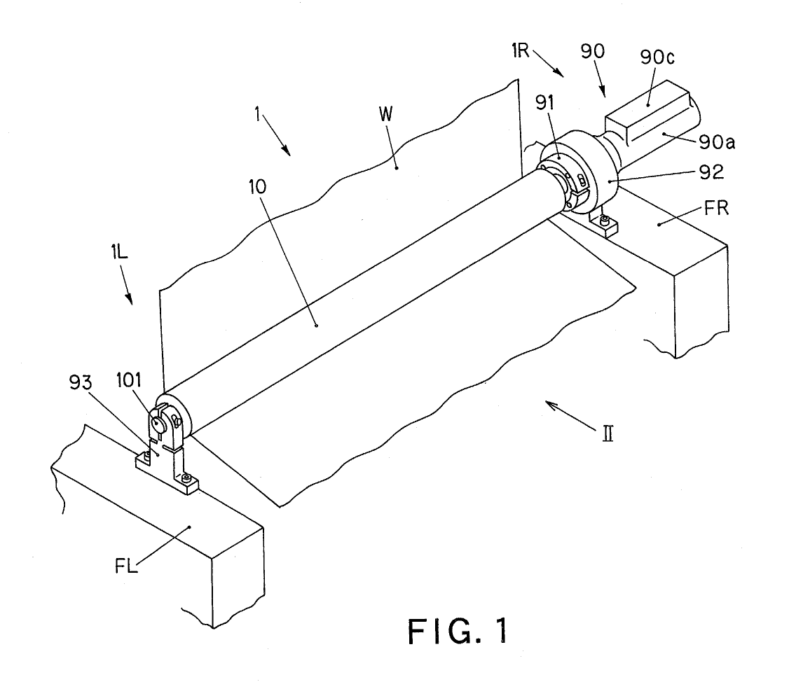

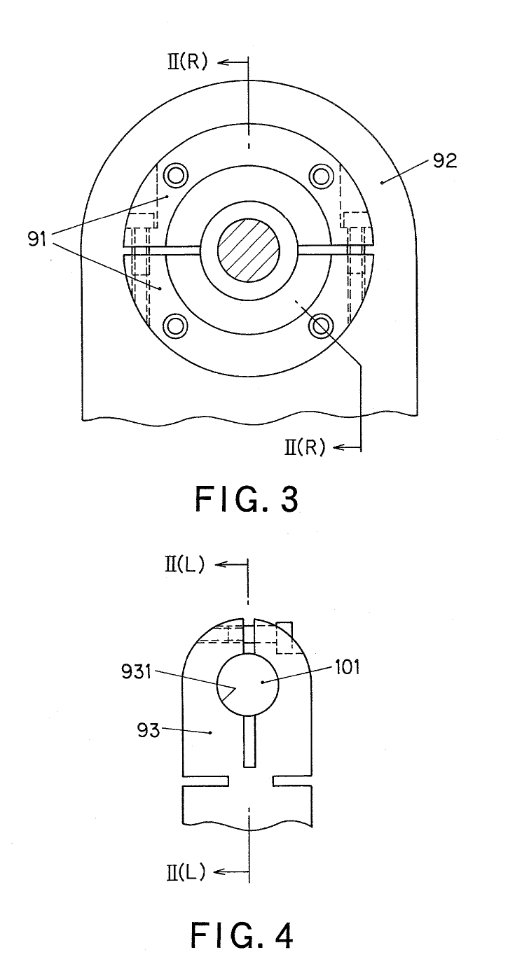

As shown in FIGS. 1 to 4, a paper-web guide apparatus according to a first embodiment has a guide member 10, which is formed of a bar-shaped member capable of transmitting vibrations and has a guide peripheral surface curved about the axis of the guide member 10. The curved peripheral surface serves as a curved vibration guide surface.

In the illustrated example, the guide member 10 is a cylindrical member having a circular cross section as viewed perpendicular to the axis.

A horn 90b of a vibration excitation unit 90 is connected to one end (right-hand end) of the guide member 10 by use of unillustrated headless screws such as set screws or stud bolts.

The vibration excitation unit 90 includes a torsion vibration generation section 90a, which in turn includes stacked piezoelectric elements (not shown). A two-piece holding member 91, attached to a frame FR via a bracket 92, holds a portion which is located between the torsion vibration generation section 90a and the horn 90b and serves as a node of vibration. Electricity is supplied to the piezoelectric elements via a terminal box 90c.

An end shaft 101 of smaller diameter is formed at the other end (left-hand end) of the guide member 10. The end shaft 101 is held by a two-piece holding portion 931 of a bracket 93 attached to a frame FL (see FIG. 4).

Operation of the paper-web guide apparatus according to the first embodiment will now be described.

In the paper-web guide apparatus shown in FIGS. 1 to 4, electrical power is supplied, via the terminal box 90c, to the unillustrated stacked piezoelectric elements of the vibration generation section 90a of the vibration excitation unit 90. The electrical power has a frequency which matches the characteristics of the piezoelectric elements. Thus, the piezoelectric elements expand and contract to thereby generate ultrasonic torsion vibration. The thus-generated ultrasonic torsion vibration is transmitted to the guide member 10 via the horn 90b.

As a result, antinodes and nodes are produced on the guide member 10. Specifically, at equally spaced axial positions, the spacing interval varying with the frequency of vibration, there are produced portions (antinodes) which displace in directions opposite each other, as in the case in which a wet cloth is wrung out, and the directions of displacement are reversed at short time intervals that vary with the frequency. In addition, between adjacent antinodes, a portion (node) appears which does not displace about the axis. In each of the regions between the antinodes and the node, displacement about the axis occurs in the same direction as in the nearest antinode, and the amount of displacement decreases gradually toward the node.

Due to this displacement, as in the case in which a wet cloth is wrung out, the outer diameter of the nodes decreases, and the outer diameter of the antinodes increases. When the displacement of the antinodes reaches a maximum, the outer diameter of the nodes becomes smallest, and the outer diameter of the antinodes becomes largest. Further, when the displacement of the antinodes becomes zero, the outer diameter of the nodes becomes largest, and the outer diameter of the antinodes becomes smallest, so that the diameters of the antinodes and nodes become equal to the original diameter of the guide member 10.

The length of the guide member 10 is n times the pitch of the nodes, where n is an integer.

In the case in which the paper web W is guided by the guide member 10, which undergoes the above-mentioned torsion vibration, whenever the displacement of the antinodes reaches a maximum, the nodes separate from the paper web W and the antinodes quickly lift the paper web W as if they hit the paper web W. Accordingly, the paper web W comes into contact with the guide surface of the guide member 10 via a very small contact area and is thus guided in a substantially floating state. Therefore, frictional resistance acting on the paper web W decreases.

Moreover, since the antinodes come into sliding contact with the paper web W while displacing about the axis, the guide surface is hardly dirtied by ink transfer.

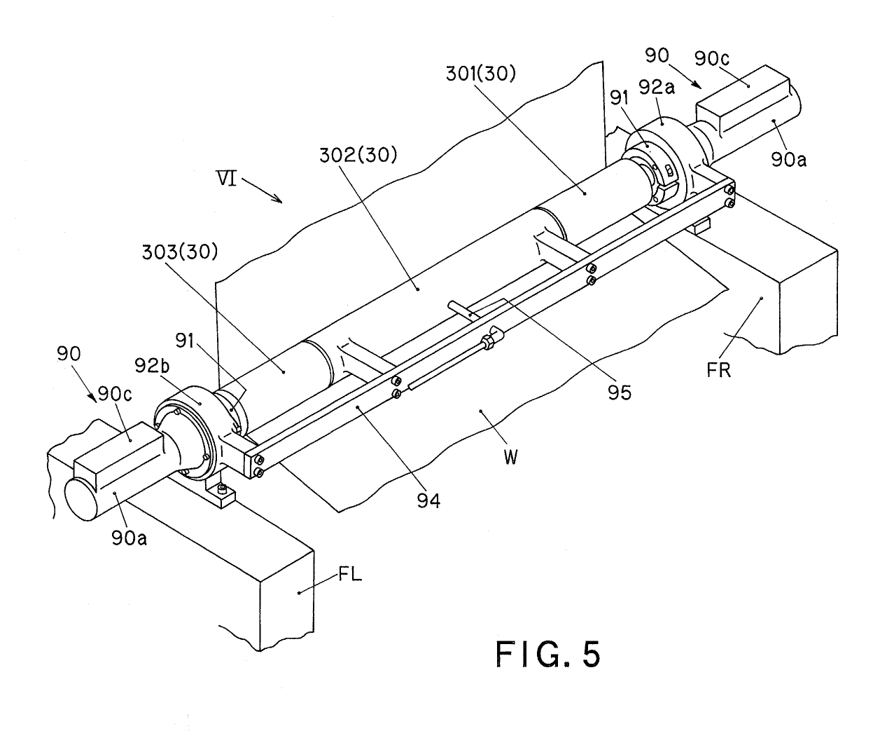

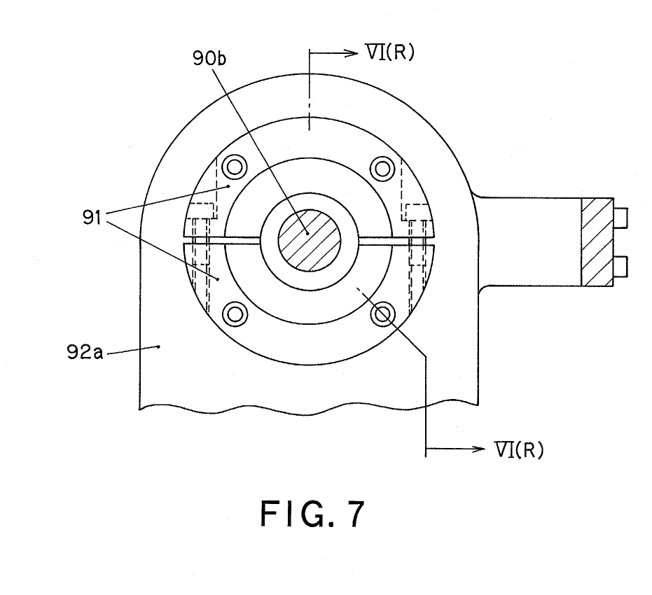

As shown in FIGS. 5 to 7, a paper-web guide apparatus according to a second embodiment has a guide member 30, which is composed of a left-side first member 301, an intermediate second member 302, and a right-side third member 303, which are axially arranged with the inner ends of the first and third members 301 and 303 being in close proximity to the opposite ends of the second member 302, respectively.

The first and third members 301 and 303 are each formed of a bar-shaped member capable of transmitting vibration and having a guide peripheral surface curved about the axis of the guide member 30. The curved peripheral surface serves as a curved vibration guide surface.

The second member 302 is formed of a circular tubular member and has a guide peripheral surface curved about the axis of the guide member 30. A plurality of small holes 304 serving as gas-jetting openings are formed in the curved guide peripheral surface over the entire length of the second member 302. In the illustrated example, the first member 301, the second member 302, and the third member 303 each assume the form of a cylindrical body having a circular cross section as viewed perpendicular to the axis, and all are of the same radius. Alternatively, the second member 302 may be slightly smaller in radius than the first and third members 301 and 303.

A horn 90b of a vibration excitation unit 90 is connected to the outer end (i.e.; the end remote from the second member 302) of each of the first and third members 301 and 303 by use of unillustrated headless screws such as set screws or stud bolts.

As in the case of the first embodiment, the vibration excitation unit 90 includes a torsion vibration generation section 90a, which in turn includes stacked piezoelectric elements (not shown). A two-piece holding member 91, attached to a frame FR or FL via a bracket 92a or 92b, holds a portion which is located between the torsion vibration generation section 90a and the horn 90b and serves as a node of vibration. Electricity is supplied to the piezoelectric elements via a terminal box 90c.

The inner ends of the first and third members 301 and 303 proximate to the second member 302 are not restrained and serve as free ends, and are disposed to face the opposite ends of the second member 302 with a predetermined gap of, for example, 0.1 mm formed therebetween. The free ends of the first and third members 301 and 303 are located inward by at least 25 mm from the lateral edges of the paper web W to be guided by the paper-web guide apparatus 3.

The second member 302 has projections (in the illustrated example, two projections are provided in the vicinity of the opposite ends of the second member 302). The projections project radially from the peripheral surface of the second member 302; specifically, from a portion other than the curved guide peripheral surface. Side projections project from the brackets 92a and 92b in parallel with the projection of the second member 302. A stay 94 extending parallel to the axis of the guide member 30 is fixed to the tips of the projections of the second member 302 and the tips of the side projections of the brackets 92a and 92b by use of bolts.

Moreover, a gas supply pipe 95, which communicates with the interior space of the second member 302 and serves as a gas supply section, projects from the peripheral surface of the second member 302; specifically, from a portion other than the curved guide peripheral surface, in parallel with the projections of the second member 302. The gas supply pipe 95 extends to the stay 94 and is connected to the pipeline of an unillustrated gas supply source via a pipe attached to the stay 94.

Operation of the paper-web guide apparatus according to the second embodiment will now be described.

In the paper-web guide apparatus shown in FIGS. 5 to 7, the first and third members 301 and 303 of the guide member 30 operate in a manner similar to that of the guide member 10 of the paper-web guide apparatus of the first embodiment.

Specifically, electrical power is supplied, via the terminal boxes 90c, to the unillustrated stacked piezoelectric elements of the vibration generation sections 90a of the vibration excitation units 90. The electrical power has a frequency which matches the characteristics of the piezoelectric elements. Thus, the piezoelectric elements expand and contract to thereby generate ultrasonic torsion vibration. The thus-generated ultrasonic torsion vibrations are transmitted to the first member 301 and the third members 303 via the corresponding horns 90b.

As a result, antinodes and nodes are produced on each of the first and third members 301 and 303. Specifically, at equally spaced axial positions which vary with the frequency of vibration, there are produced portions (antinodes) which displace in directions opposite each other, as in the case in which a wet cloth is wrung out, and the directions of displacement are reversed at short time intervals that vary with the frequency. In addition, between adjacent antinodes, a portion (node) appears which does not displace about the axis. In each of the regions between the antinodes and the node, displacement about the axis occurs in the same direction as in the nearest antinode, and the amount of displacement decreases gradually toward the node.

Due to this displacement, as in the case in which a wet cloth is wrung out, the outer diameter of the nodes decreases, and the outer diameter of the antinodes increases. When the displacement of the antinodes reaches a maximum, the outer diameter of the nodes becomes smallest, and the outer diameter of the antinodes becomes largest. Further, when the displacement of the antinodes becomes zero, the outer diameter of the nodes becomes largest, and the outer diameter of the antinodes becomes smallest, so that the diameters of the antinodes and nodes become equal to the original diameter of the first and third members 301 and 303. The length of the first and third members 301 and 303 is n times the pitch of the nodes, where n is an integer.

In the case in which the paper web W is guided by the first and third member 301 and 303, which undergoes the above-mentioned torsion vibration, whenever the displacement of the antinodes reaches a maximum, the nodes separate from the paper web W and the antibodies quickly lift the paper web W as if they hit the paper web W. Accordingly, the paper web W comes into contact with the guide surfaces of the first and third members 301 and 303 via very small contact areas and is thus guided in a substantially floating state. Therefore, frictional resistance acting on the paper web W decreases.

Moreover, since the antinodes come into sliding contact with the paper web W while displacing about the axis, the guide surface is hardly dirtied by ink transfer.

Meanwhile, a gas is supplied to the interior space of the second member 302 from the unillustrated gas supply source via the gas supply pipe 95. Thus, the gas is jetted from the plurality of small holes 304 formed in the guide peripheral surface of the second member 302 over the entire length thereof. As a result, a gas layer is formed between the guide peripheral surface and the paper web W, and thus, the paper web W is guided in a substantially floating state; i.e., in a state in which the area of contact with the guide peripheral surface has been reduced to a very small value or zero. Therefore, frictional resistance acting on the paper web W decreases.

When the second member 302 is slightly smaller in outer diameter than the first and third members 301 and 303, a gas layer having a thickness corresponding to the difference in diameter is produced in a stable manner, because the tension acting on the paper web W becomes stable when the paper web W maintains the same level over its entire width, including both lateral sides. Therefore, the state in which the paper web W floats from the guide peripheral surface can be maintained more stably.

Since the lateral edge portions of the paper web W are lifted from the guide peripheral surface by the action of the torsion vibration, the lateral edge portions of the paper web W are not lifted and are not moved laterally by the action of jetted gas.

Notably, a test performed by the inventor reveals that when the gas jetting is effected at a point which is separated from the corresponding lateral edge of the paper web W by an amount equal to or less than 25 mm, the lateral edge portions of the paper web W are lifted by the action of jetted gas, with resultant lateral movement of the paper web W. Therefore, the inner edges of the first and third members 301 and 303 located adjacent to the second member 302 are preferably separated inward, by an amount equal to or less than 30 mm, from the corresponding lateral edges of the paper web W to be guided by the paper-web guide apparatus 3.

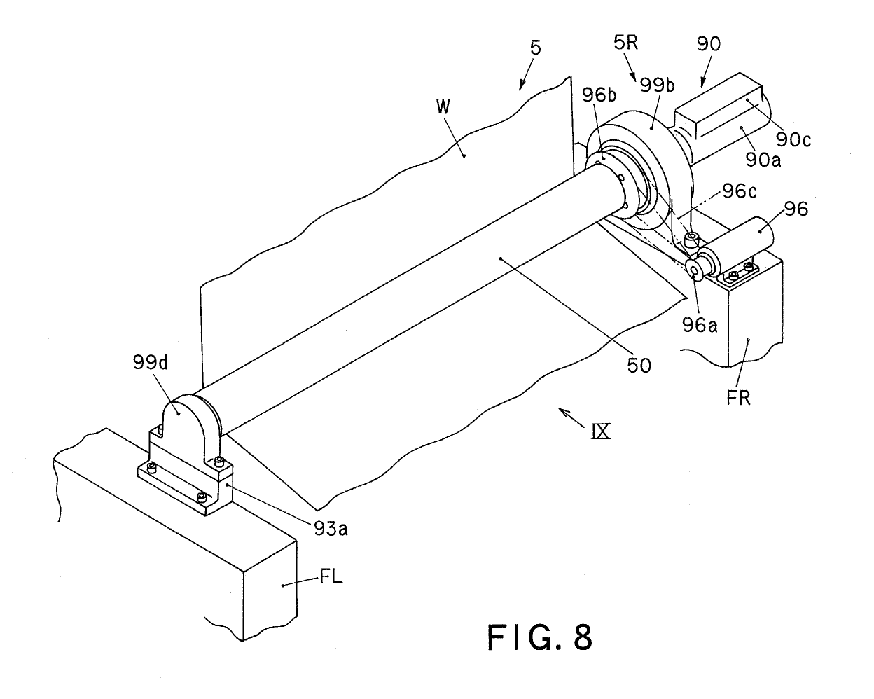

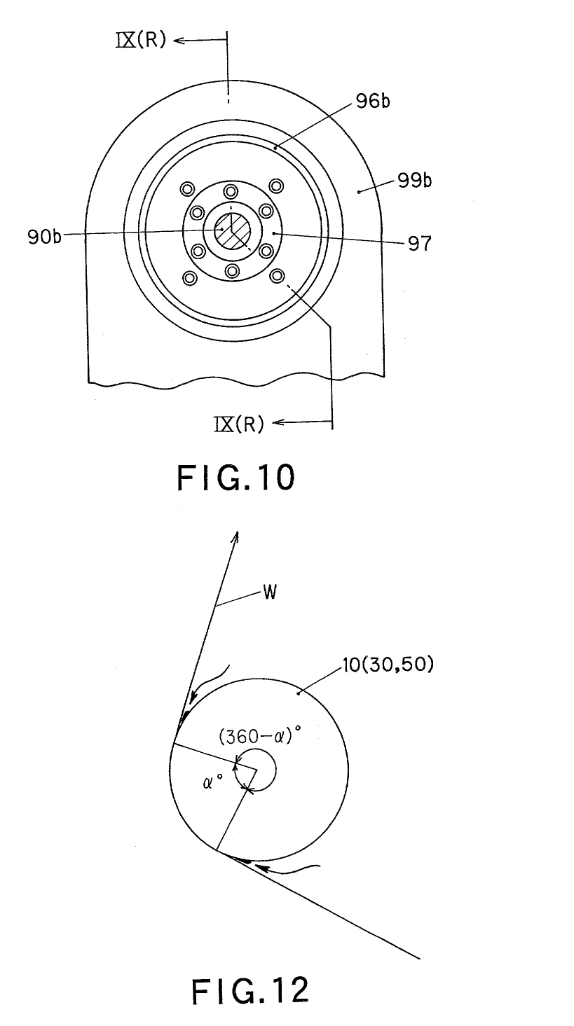

As shown in FIGS. 8 to 10, a paper-web guide apparatus according to a third embodiment has a guide member 50, which is formed of a bar-shaped member capable of transmitting vibration and has a guide peripheral surface curved about the axis thereof. The curved peripheral surface serves as a curved vibration guide surface. In the illustrated example, the guide member 50 is a cylindrical member having a circular cross section as viewed perpendicular to the axis.

A horn 90b of a vibration excitation unit 90 is connected to one end (right-hand end) of the guide member 50 by use of unillustrated headless screws such as set screws or stud bolts.

As a whole, the vibration excitation unit 90 has a shape obtained through combining a cylindrical column and a truncated cone while their center axes are aligned with the axis of the guide member 50. The vibration excitation unit 90 includes a torsion vibration generation section 90a, which in turn includes stacked piezoelectric elements (not shown). Moreover, unillustrated brushes are in contact with a power input section of the piezoelectric elements, and electricity is supplied to the brushes via the terminal box 90c.

At a portion which is located between the torsion vibration generation section 90a and the horn 90b and corresponds to a vibration node, a toothed pulley 96b is attached to the vibration excitation unit 90 via a fixing member 97 in such a manner that the center axis of the pulley 96b coincides with the center axis of the vibration excitation unit 90.

Moreover, a bearing housing 99b is attached to the frame FR; and a rotary sleeve 98 is rotatably supported on the bearing housing 99b via bearings 99a. The toothed pulley 96b is attached to the rotary sleeve 98 in such a manner that the center axis of the pulley 96b coincides with the center axis of the rotary sleeve 98. As a result, the vibration excitation unit 90 and the guide member 50 integrated therewith are attached to the rotary sleeve 98 via the toothed pulley 96b.

An electric motor 96 serving as a displacement drive unit is attached to the frame FR. A toothed belt 96c is extended between and wound around a toothed pulley 96a attached to the output shaft of the electric motor 96 and the toothed pulley 96b attached to the vibration excitation unit 90.

An end shaft 501 of smaller diameter is formed at the other end (left-hand end) of the guide member 50. Further, a bearing housing 99d is attached to the frame FL via a bracket 93a; and the end shaft 501 is rotatably supported on the bearing housing 99d via a bearing 99c.

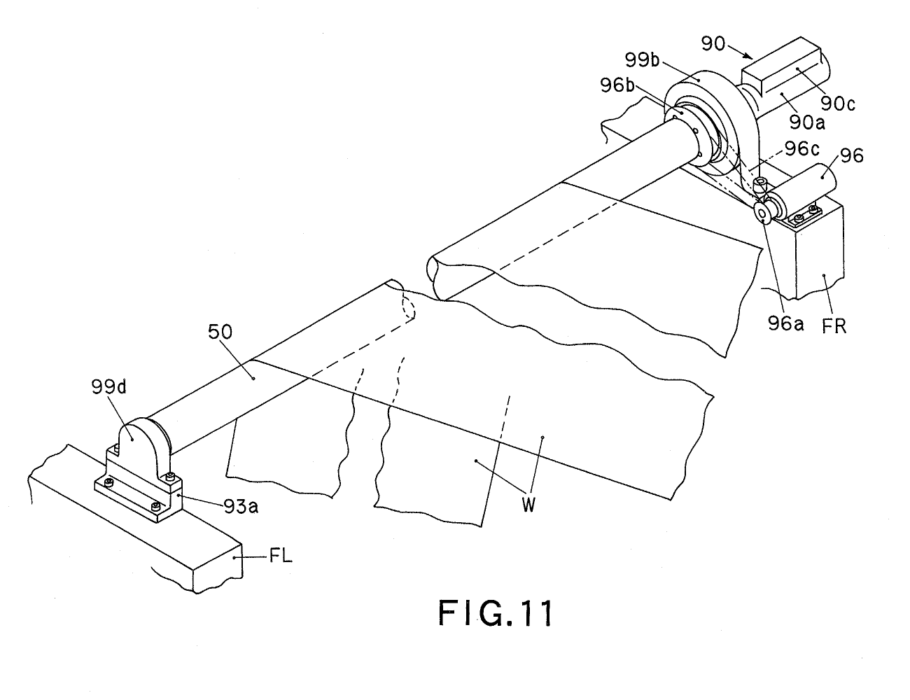

As shown in FIG. 11, the paper-web guide apparatus of the third embodiment can be used as an angle bar. Needless to say, the paper-web guide apparatuses of the first and second embodiments can also be used as angle bars.

Operation of the paper-web guide apparatus of the third embodiment will now be described.

In the paper-web guide apparatus shown in FIGS. 8 to 11, the guide member 50 operates in a manner similar to that of the guide member 10 described in the first embodiment.

That is, electrical power is supplied, via the terminal box 90c, to the unillustrated stacked piezoelectric elements of the vibration generation section 90a of the vibration excitation unit 90. The electrical power has a frequency which matches the characteristics of the piezoelectric elements. Thus, the piezoelectric elements expand and contract to thereby generate ultrasonic torsion vibration. The thus-generated ultrasonic torsion vibration is transmitted to the guide member 50 via the horn 90b.

As a result, antinodes and nodes are produced on the guide member 50. Specifically, at equally spaced axial positions, the spacing interval varying with the frequency of the vibration, there are produced portions (antinodes) which displace in directions opposite each other, as in the case in which a wet cloth is wrung out, and the directions of displacement are reversed at short time intervals that vary with the frequency. In addition, between adjacent antinodes, a portion (node) appears which does not displace about the axis. In each of the regions between the antinodes and the node, displacement about the axis occurs in the same direction as in the nearest antinode, and the amount of displacement decreases gradually toward the node.

Due to this displacement, as in the case in which a wet cloth is wrung out, the outer diameter of the nodes decreases, and the outer diameter of the antinodes increases. When the displacement of the antinodes reach a maximum, the outer diameter of the nodes becomes smallest, and the outer diameter of the antinodes becomes largest. Further, when the displacement of the antinodes becomes zero, the outer diameter of the nodes becomes largest, and the outer diameter of the antinodes becomes smallest, so that the diameters of the antinodes and nodes become equal to the original diameter of the guide member 50. The length of the guide member 50 is n times the pitch of the nodes, where n is an integer.

In the case in which the paper web W is guided by the guide member 50, which undergoes the above-mentioned torsion vibration, whenever the displacement of the antinodes reach a maximum, the nodes separate from the paper web W and the antibodies quickly lift the paper web W as if they hit the paper web W. Accordingly, the paper web W comes into contact with the guide surface of the guide member 50 via a very small contact area and is thus guided in a substantially floating state. Therefore, frictional resistance acting on the paper web W decreases.

Moreover, since the antinodes come into slide contact with the paper web W while displacing about the axis, the guide surface is hardly dirtied by ink transfer.

In the first embodiment shown in FIGS. 1 to 4 and the second embodiment shown in FIGS. 5 to 7, the guide member 10 and the guide member 30 (the left-side first member 301 and the right-side third member 303) displace back and forth about the axis; however, the amount of displacement is small. Therefore, as shown in FIG. 12, debris accumulates on the curved guide peripheral surface of the guide member 10 or the guide member 30 in an area immediately before a position at which guiding of the paper web W starts; i.e., a contact start position in a maximally displaced state and in an area immediately after a position at which guiding of the paper web W ends; i.e., a contact end position in a maximally displaced state.

Specifically, ink, paper powder, or the like on the surface of the paper web W remain in the area immediately before the position at which contact between the paper web W and the guide surface starts, because the curved guide peripheral surface prevents entry of the ink, paper powder, or the like into the space between the paper web W and the curved guide peripheral surface. In spite of the entry prevention action of the curved guide peripheral surface, some of the ink, paper powder, or the like may enter and pass through the space between the paper web W and the curved guide peripheral surface. A portion of such ink, paper powder, or the like may fail to follow travel of the paper web W and remain in the area immediately after the position at which contact between the paper web W and the guide surface ends. The ink, paper powder, or the like is pressed and accumulated in the area immediately before the contact start position in the maximally displaced state and in the area immediately after the contact end position in the maximally displaced state. Such accumulated debris may break, fall, and dirty the paper web.

In view of the above problem, in the third embodiment, the contact-start-side area and the contact-end-side area of the curved guide peripheral surface in which debris accumulates are moved at all times in order to prevent accumulation of debris on the curved guide peripheral surface. That is, when the electric motor 96 is operated, rotation of the output shaft of the motor 96 is transmitted to the guide member 50 via the toothed pulley 96a fixed to the output shaft of the motor 96, the toothed pulley 96b rotating together with the guide member 50 via the vibration excitation unit 90, and the toothed belt 96c wound around the toothed pulley 96a and the toothed pulley 96b. As a result, the guide member 50 is rotated so as to move the curved guide peripheral surface at a speed different from the travel speed of the paper web W.

With this operation, the position at which contact between the paper web W and the guide surface starts and the position at which contact between the paper web W and the guide surface ends can be changed at all times, and the curved guide peripheral surface of the guide member 50 can be scraped away by means of the paper web W when the torsion displacement thereof is zero. Thus, accumulation of debris on the curved guide peripheral surface of the guide member 50 is prevented.

In the above-described embodiment, the guide member 50 is continuously rotated in a constant direction. However, when the paper web W is wound around the curved guide peripheral surface over a winding angle a (i.e., when the angle between the position at which contact between the paper web W and the guide surface starts and the position at which contact between the paper web W and the guide surface ends is α), the guide member 50 may be rotated back and forth over an angle greater than 360°−α. In the above-described embodiment, the motor 96 rotates the guide member 50 only. However, a plurality of guide members may be rotated by the single motor 96.

The paper-web guide apparatus according to the present invention can greatly reduce frictional resistance acting on the paper web while maintaining the state in which the paper web stably travels along a proper path, and can avoid application of large tension onto the travelling paper web. In addition, even when the guided paper web comes into contact with the guide surface, a portion of the guide surface which comes into contact with the paper web is hardly dirtied.

Moreover, the paper-web guide apparatus according to the present invention has a simplified structure, and therefore can be manufactured at reduced cost. In addition, the paper-web guide apparatus according to the present invention can reduce the frequency of occurrence of malfunctions and facilitates maintenance considerably, as compared with the case in which the paper-web guide apparatus has a complicated structure.

Obviously, numerous modifications and variations of the present invention are possible in light of the above teachings. It is therefore to be understood that within the scope of the appended claims, the present invention may be practiced otherwise than as specifically described herein.

What is claimed is:

1. A paper-web guide apparatus for a processing apparatus which processes a paper web while causing the paper web to travel, the paper-web guide apparatus comprising:
a guide member having a vibration guide surface which is curved about an axis and is adapted to guide the paper web toward a desired direction; and
a vibration excitation unit for vibrating the guide member about the axis to thereby generate ultrasonic torsion vibration on the curved vibration guide surface.

2. A paper-web guide apparatus for a processing apparatus which processes a paper web while causing the paper web to travel, the paper-web guide apparatus comprising:
a guide member having a guide surface which is curved about an axis and adapted to guide the paper web toward a desired direction, the guide surface including curved vibration guide surfaces for guiding at least lateral edges of the paper web and portions in the vicinity thereof, and a curved gas-jetting guide surface;
a vibration excitation unit for vibrating the guide member about the axis to thereby generate ultrasonic torsion vibration on the vibration guide surfaces; and
a gas supply section which is connected to gas-jetting openings formed in the gas jetting guide surface.

3. A paper-web guide apparatus according to claim 2, wherein the curved guide surface is axially divided into three surfaces, and the center surface serves as the curved gas-jetting guide surface.

4. A paper-web guide apparatus for a processing apparatus which processes a paper web while causing the paper web to travel, the paper-web guide apparatus comprising:
a guide member having a vibration guide surface which is curved about an axis, is displacable about the axis, and is adapted to guide the paper web toward a desired direction;
a vibration excitation unit for vibrating the guide member about the axis to thereby generate ultrasonic torsion vibration on the vibration guide surface; and
a displacement drive unit for displacing the curved vibration guide surface about the axis.

5. A paper-web guide apparatus according to any one of claims 1 to 4, wherein the guide member has a circular cross section as viewed perpendicular to the axis of the guide member.
